(19) United States
(12) Patent Application Publication
(10) Pub. No.: US 2024/0117154 A1
(43) Pub. Date: Apr. 11, 2024

(54) VIBRATING DIAPHRAGM OF SOUND-PRODUCING APPARATUS AND SOUND-PRODUCING APPARATUS

(71) Applicant: Goertek Inc., Weifang, Shandong (CN)

(72) Inventors: WEIFENG PENG, Weifang (CN); Fengguang Ling, Weifang (CN); Chun Li, Weifang (CN); Chunla Liu, Weifang (CN)

(73) Assignee: Goertek Inc., Weifang, Shandong (CN)

(21) Appl. No.: 17/767,661

(22) PCT Filed: Dec. 25, 2019
(86) PCT No.: PCT/CN2019/128172

§ 371 Date: Apr. 8, 2022

(30) Foreign Application Priority Data
Oct. 31, 2019 (CN) 201911063154.4

(51) Int. Cl. C08K 13/02; H04R 7/02; H04R 31/00

(52) U.S. Cl. CPC C08K 13/02; H04R 7/02; H04R 31/003; H04R 2307/023; H04R 2307/025

(57) ABSTRACT

Disclosed are a vibrating diaphragm of a sound-producing apparatus and the sound-producing apparatus. The vibrating diaphragm includes at least one elastomer layer, wherein the elastomer layer is made of butadiene rubber; the butadiene rubber is any one of nickel butadiene rubber, rare earth butadiene rubber and cobalt butadiene rubber, and a content of cis-form is greater than 80% to 100%. The vibrating diaphragm of the present disclosure can maintain excellent acoustic performance under extreme conditions of low temperature. (FIG. 1)

### CROSS-REFERENCE TO RELATED APPLICATIONS

This application is a National Stage of International Application No. PCT/CN2019/128172, filed on Dec. 25, 2019, which claims priority to Chinese Patent Application No. 201911063154.4, filed on Oct. 31, 2019, both of which are hereby incorporated by reference in their entireties.

### TECHNICAL FIELD

The present disclosure relates to the technical field of acoustical devices, in particular to a vibrating diaphragm for a sound-producing apparatus and the sound-producing apparatus.

### BACKGROUND

With the rapid development of science and technology, various intelligent devices are continuously evolving. In recent years, electronic products such as intelligent wearable products and earphones are developing rapidly, and even higher demands have been put forward on their acoustic performance.

Consequently, higher demands are also put forward to manufacturing materials of the vibrating diaphragm, which is a very critical acoustic part in sound-producing apparatuses. One of the demands is for normal operation at extreme conditions of high or low temperatures while maintaining original acoustic performance.

At the current stage, common materials for manufacturing the vibrating diaphragm, for example, in Driver and Watch, are polyether ketone, polyetherimide, silica gel, polyurethane and the like. However, these existing materials hardly can satisfy the acoustic performance necessities under the extreme conditions of high or low temperatures.

Thus, it is necessary to provide a novel technical solution to solve the problems in the prior art.

### SUMMARY

An object of the present disclosure is to provide a novel technical solution of a vibrating diaphragm of a sound-producing apparatus and the sound-producing apparatus.

According to one aspect of the present disclosure, provided is a vibrating diaphragm of a sound-producing apparatus, the vibrating diaphragm including at least one elastomer layer the elastomer layer is made of butadiene rubber;

The butadiene rubber is any one of nickel butadiene rubber, rare earth butadiene rubber and cobalt butadiene rubber, wherein a content of cis-form is greater than 80% to 100%.

Optionally, an inorganic filler reinforcing agent is blended in the butadiene rubber, and the inorganic filler reinforcing agent is at least one of carbon black, white carbon black, nano titanium dioxide, talc powder, precipitated calcium carbonate and barium sulfate.

Optionally, an inorganic filler reinforcing agent is blended in the butadiene rubber, and the inorganic filler reinforcing agent is at least one of carbon black, white carbon black, nano titanium dioxide, talc powder, precipitated calcium carbonate and barium sulfate.

Optionally, the content of the inorganic filler reinforcing agent is 15% to 90% of the total amount of the butadiene rubber.

Optionally, a vulcanizer is blended in the butadiene rubber, and the vulcanizer is at least one of a sulfur vulcanizer, an organic peroxide vulcanizer and a thiuram vulcanizer.

Optionally, the content of the sulfur vulcanizer is 0.3% to 1.5% of the total amount of the butadiene rubber.

Optionally, the thiuram polysulfide is at least one of tetramethylthiuram monosulfide, tetramethylthiuram disulfide, tetraethylthiuram disulfide, tetrabutylthiuram disulfide, diisobutylthiuram disulfide, bis(1,5-pentylidene) thiuram tetrasulfide.

Optionally, the organic peroxide vulcanizer is at least one of 1,3-1,4-di(tertiary butyl peroxy-isopropyl)benzene, dicumyl peroxide, 2,5-dimethyl-2,5-bis(tertiary butyl peroxy) hexane, tertiary butyl dicumyl peroxide, 2,5-dimethyl-2,5-bis(peroxy tertiary butyl)-3-hexyne, 4,4′-bis(tertiary butyl peroxy) N-butyl valerate, 1,1′-bis(tertiary butyl peroxy)-3,3,5-trimethyl-cyclohexane, 2,4-dichlorobenzoyl peroxide, and the content of the organic peroxide vulcanizer is 2% to 8% of the total amount of the butadiene rubber.

Optionally, an antiaging agent is blended in the butadiene rubber, the antiaging agent is at least one of antiaging agent of N-445, antiaging agent 246, antiaging agent 4010, antiaging agent SP, antiaging agent RD, antiaging agent ODA, antiaging agent OD and antiaging agent WH-02, the mass fraction of the nitrile rubber is 100 parts, and the content of the antiaging agent is 0.5% to 10% of the total amount of the butadiene rubber.

Optionally, the content of the antiaging agent is 1% to 5% of the total amount of the butadiene rubber.

Optionally, a plasticizer is blended in the butadiene rubber, the plasticizer is at least one of an aliphatic diester plasticizer, a phthalate plasticizer, a benzene polyacid plasticizer, a benzoate plasticizer, a polyalcohol ester plasticizer, a chlorinated hydrocarbon plasticizer, an epoxy plasticizer, a citrate plasticize and a polyester plasticizer, and the content of the plasticizer is 1% to 10% of the total amount of the butadiene rubber.

Optionally, the content of the plasticizer is 3% to 7% of the total amount of the butadiene rubber.

Optionally, an internal releasing agent is blended in the butadiene rubber, the internal releasing agent is at least one of stearic acid, octadecylamine, alkyl phosphate and α-octadecyl-ω-hydroxyl polyoxyethylene phosphate, and the content of the internal releasing agent is 0.5% to 5% of the total amount of the butadiene rubber.

Optionally, the content of the internal releasing agent is 1% to 3% of the total amount of the butadiene rubber.

Optionally, the vibrating diaphragm is a single-layered vibrating diaphragm, and the single-layered vibrating diaphragm is composed of a butadiene rubber film layer; or
the vibrating diaphragm is a composite vibrating diaphragm, the composite vibrating diaphragm includes two, three, four or five film layers, and the composite vibrating diaphragm at least includes a butadiene rubber film layer.

Optionally, a thickness of the butadiene rubber film layer is 10 μm to 200 μm.

Optionally, a thickness of the butadiene rubber film layer is 30-200 μm.

Optionally, a hardness of the diaphragm rubber is 30 A to 95 A.

Optionally, a glass-transition temperature of the diaphragm rubber ranges from minus 120° C. to 0° C.

Optionally, a loss factor of the diaphragm rubber at a room temperature is greater than 0.06.

Optionally, an elongation at break of the diaphragm rubber is greater than 100%.

According to another aspect of the present disclosure, a sound-producing apparatus is provided. The sound-producing apparatus includes a sound-producing apparatus main body and the vibrating diaphragm, the vibrating diaphragm being disposed on the sound-producing apparatus main body and the vibrating diaphragm being configured to vibrate to generate a sound.

The inventor of the present disclosure founds that the vibrating diaphragm made of a conventional material hardly meets necessities of acoustic performance under the condition of extremely low temperature. Thus, the technical task to be achieved or the technical problem to be solved is never thought or unexpected by those skilled in the art, and the present disclosure is a novel technical solution.

The present disclosure has the beneficial effects that: the present disclosure discloses a vibrating diaphragm made of the butadiene rubber material, the vibrating diaphragm is good in comprehensive performance, can keep excellent rigidity, rebound resilience and damping property at a very low temperature, that is, it can work normally under an extreme condition of low-temperature. Thus, the sound-producing apparatus can be applied to an extremely severe environment, and can keep a good state of the acoustic performance thereof.

Other features and advantages of the present disclosure will be readily apparent from the following detailed description of exemplary embodiments of the present disclosure with reference to the drawings.

### BRIEF DESCRIPTION OF THE DRAWINGS

The accompanying drawings, which are incorporated into this specification and constitute a part thereof, illustrate embodiments of the present disclosure and, together with the description, serve to explain the principles of the present disclosure.

FIG. 1 shows a test curve of total harmonic distortion of the vibrating diaphragm provided by the present disclosure and a conventional vibrating diaphragm.

FIG. 2 shows a test curve of vibration displacement of different parts of the vibrating diaphragm of the sound-producing apparatus of an embodiment of the present disclosure at different frequencies.

FIG. 3 shows a test curve of vibration displacement of different parts of the conventional vibrating diaphragm at different frequencies.

FIG. 4 shows an impedance curve of the vibrating diaphragms with different hardness and with the same thickness.

FIG. 5 shows a test curve of loudness of the vibrating diaphragm provided by the embodiment of the present disclosure and an existing conventional vibrating diaphragm.

### DETAILED DESCRIPTION

Detail description on the various exemplary embodiments of the present disclosure will be made below with reference to the drawings. It is to be noted that unless otherwise specified, relative arrangement, digital expression formulae and numerical values of components and steps illustrated in these embodiments do not limit the scope of the present disclosure.

Description to at least one exemplary embodiment is in fact illustrative only, and is in no way limiting to the present disclosure or application or use thereof.

Techniques, methods and devices known to those skilled in the prior art may not be discussed in detail; however, the techniques, methods and devices shall be regarded as part of the description where appropriate.

In all the illustrated and discussed examples, any specific value shall be explained as be exemplary merely rather than be restrictive. Thus, other examples of exemplary embodiments may have different values.

It is to be noted that similar reference numbers and alphabetical letters represent similar items in the drawings below, such that once a certain item is defined in a drawing, further discussion thereon in the subsequent drawings is no longer necessary.

According to an embodiment of the present disclosure, provided is a vibrating diaphragm of a sound-producing apparatus. The vibrating diaphragm includes at least one elastomer layer, wherein the elastomer layer is made of butadiene rubber. The vibrating diaphragm can be applied widely to various sound-producing apparatuses, in particular to a miniature sound-producing apparatus.

The butadiene rubber is any one of nickel butadiene rubber, rare earth butadiene rubber and cobalt butadiene rubber, wherein a content of cis-form is greater than 80% to 100%. For example, the content of cis-form is preferably 95% to 99% among the three. The performance of the three types of butadiene rubber can be shown in a table 1, and it has good comprehensive performance such as rigidity and rebound resilience.

The table 1 is a comparison list diagram between the performances of the three types of butadiene rubber in the present disclosure.

| | Nickel | | Cobalt |
|---|---|---|---|
| | butadiene | Rare earth | butadiene |
| Item | rubber | butadiene rubber | rubber |
| Tensile strength (MPa) | 14.7 | 20 | 17.6 |
| Elongation at break (%) | 730 | 741 | 746 |
| 300% stress at definite | 4.19 | 6.57 | 5.35 |
| elongation (MPa) | | | |
| Tear strength (kN/m) | 57.3 | 61.1 | 57.7 |
| Shore Hardness A (HA) | 56 | 57 | 58 |
| Resilience (%) | 48 | 52 | 50 |
| Akron abration (cm³/Kw) | 0.062 | 0.040 | 0.054 |
| Temperature rise of | 26.3 | 22.3 | 25.5 |
| compression (° C.) | | | |

The molecular structural formula of the butadiene rubber can be as follows:

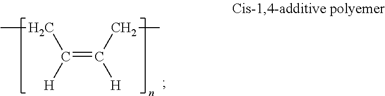

In the above molecular formula, n is a natural number.

The higher the content of cis-form in the butadiene rubber is, the more regular the arrangement of molecules is. In a stretching process, it shows higher directional entropy and needs higher tensile strength, such that the product is higher in strength. In addition, when the content of cis-form is increased, carbon-carbon single bonds in the molecules are easier to rotate, in particular, the single bonds on two sides of double bonds are easier to rotate, the bonds are better in flexibility, and the product shows very excellent rebound resilience and cold resistance. (Glass-transition temperature Tg is minus 110° C.)

The vibrating diaphragm provided by the present disclosure is made of the above butadiene rubber material. The vibrating diaphragm is good in comprehensive performance. The vibrating diaphragm still can keep excellent elasticity, rigidity and damping property at a very low temperature, that is, it can be used normally under an extreme low-temperature condition. Thus, the sound-producing apparatus can be applied to an extremely severe environment, and meanwhile, the acoustic performance thereof keeps a good state.

Optionally, an inorganic filler reinforcing agent can be blended in the butadiene rubber. The inorganic filler reinforcing agent includes at least one of carbon black, white carbon black, nano titanium dioxide, talc powder, precipitated calcium carbonate and barium sulfate. Preferably, the inorganic filler reinforcing agent includes at least one of carbon black, white carbon black and nano titanium dioxide.

Further, under a circumstance that the mass fraction of the butadiene rubber is 100 parts, the mass fraction of the inorganic filler reinforcing agent is 15 to 90 parts, that is, the content of the inorganic filler reinforcing agent is 15% to 90% of a total amount of the butadiene rubber.

Compared with rubber such as natural rubber and butadiene styrene rubber, as the butadiene rubber used in the present disclosure has good structural regularity and flexibility, the butadiene rubber has more excellent wetting ability, and more inorganic filler reinforcing agent can be blended thereinto, such that the production cost of the sizing material can be lowered.

The surface of the inorganic filler reinforcing agent has radicals such as hydrogen, carboxyl, lactonyl, free radical, quinonyl and the like capable of being substituted, reduced, oxidized and the like. After the reinforcing agent is blended into the butadiene rubber, as a result of a strong interaction between the reinforcing agent and an interface of the polymer block of the butadiene rubber, the molecular chain is relatively prone to sliding on the surfaces of microparticles of the reinforcing agent when the butadiene rubber is stressed, but is not prone to being separated from the microparticles of the reinforcing agent. The butadiene rubber and the microparticles of the reinforcing agent form a strong bond capable of sliding, such that the mechanical strength is increased.

In addition, particle size, structural property and surface activity of the inorganic filler reinforcing agent are primary investigation factors to investigate the rubber filler. Typically, the three factors are interdependent. That is, the smaller the particle size of the inorganic filler reinforcing agent is, the larger the specific surface area of the corresponding filler is; the larger the specific surface area of the corresponding filler is, the higher the corresponding surface activity is.

By taking carbon black as an example, the carbon black is primarily composed of carbon element which accounts for 95% to 99%, belonging to a kind of graphite crystal. The carbon black is of an amorphous structure, and particles form an aggregate by means of physical and chemical combination. The primary structure of carbon black is formed by the aggregates, and meanwhile, the aggregates having Van der Waals' force or hydrogen bonds can be aggregated to form a spatial network structure, i.e., a secondary structure of carbon black. The surface of the carbon black has radicals such as hydrogen, carboxyl, lactonyl, free radical and quinonyl capable of being substituted, reduced, oxidized and the like. After the carbon black is blended into the elastomer, as a result of a strong interaction between the surface of the carbon black and an interface of the poly 1,4-butadiene molecular interface, when a material is stressed, the molecular chain is easy to slide on the surface of the carbon black but is not easy to be separated from the carbon black. The butadiene rubber and the carbon black form a strong bond capable of sliding, such that the mechanical strength is increased.

In an embodiment, under a circumstance that the mass fraction of the butadiene rubber is 100 parts, optionally, the mass fraction of the inorganic filler reinforcing agent is 15 to 85 parts, that is, the content of the inorganic filler reinforcing agent is 15 to 85% of a total amount of the butadiene rubber. By taking the carbon black as the inorganic filler reinforcing agent as an example, when the mass fraction of the carbon black is 10, both the mechanical strength and the elongation at break of the butadiene rubber material are relatively small, which is because the carbon black dispersed in a matrix unevenly hardly plays a reinforcing role due to a relatively small amount. Along with increase of the adding amount of the carbon black, the mechanical strength of the butadiene rubber material is increased, and the elongation at break thereof is decreased gradually. Under this circumstance, the prepared vibrating diaphragm may have a diaphragm breaking risk in long-term use. Thus, optionally, when the mass fraction of the butadiene rubber is 15 to 80 parts, that is, the content of the inorganic filler reinforcing agent is 15-80% of a total amount of the butadiene rubber, a requirement of the present disclosure on performance of the vibrating diaphragm can be better met. It is more ideal that the mass fraction of the inorganic filler reinforcing agent is 30-70 parts, that is, the content of the inorganic filler reinforcing agent is 30-70% of a total amount of the butadiene rubber. Of course, those skilled in the art can make flexible adjustment according to a specific requirement, which is not limited herein.

Optionally, an antiaging agent can be blended in the butadiene rubber. The antiaging agent, for example, can be at least one of antiaging agent N-445, antiaging agent 246, antiaging agent 4010, antiaging agent SP, antiaging agent RD, an antiaging agent ODA, antiaging agent OD and antiaging agent WH-02. Moreover, under a circumstance that the mass fraction of the butadiene rubber is 100 parts, the mass fraction of the antiaging agent is 0.5 to 10 parts, that is, the content of the antiaging agent is 0.5% to 10% of a total amount of the butadiene rubber.

With the elapse of time, the molecular chains of butadiene rubber gradually break during use and generate dissociative free radicals to accelerate aging due to influence of factors such as oxygen and an ultraviolet lamp, known as the natural aging phenomenon of the butadiene rubber. In the present disclosure, by blending the antiaging agent in the butadiene rubber, a self-catalyzed active free radicals generated in butadiene rubber can be prevented or suspended and alleviated. It is to be noted that if the adding amount of the antiaging agent is too small, an effect of prolonging the service life of the butadiene rubber may not be achieved. If the adding amount of the antiaging agent is too large, as the antiaging agent is hardly inter-soluble with the butadiene rubber fully and is hardly dispersed uniformly, the mechanical property of the butadiene rubber may be declined in this case. Therefore, under a circumstance that the mass fraction of the butadiene rubber is 100 parts, it is necessary to control the mass fraction of the antiaging agent at 0.5 to 10 parts. Preferably, the mass fraction of the antiaging agent is 1 to 5 parts, that is, the content of the antiaging agent is 1% to 5% of the total amount of the butadiene rubber. Of course, those skilled in the art can make adjustments according to a specific requirement as appropriate, which is not limited herein.

Optionally, the plasticizer can be blended in the butadiene rubber. The plasticizer is at least one of an aliphatic diester plasticizer, a phthalate plasticizer (for example, a phthalate plasticizer, a polyethylene terephthalate plasticizer), a benzene polyacid plasticizer, a benzoate plasticizer, a polyalcohol ester plasticizer, a chlorinated hydrocarbon plasticizer, an epoxy plasticizer, a citrate plasticizer and a polyester plasticizer.

Molecules of the plasticizer are much smaller than those of butadiene rubber. They can move in poly 1,4-butadiene molecules to provide a space needed by movement to a chain segment conveniently, thereby reducing glass-transition temperature of the material, increasing cold resistance of the material and improving the machining property the material. Excessive plasticizer, on the contrary, will separate from the interior of the material and reduce the mechanical property of the material.

In an embodiment, under the circumstance that the mass fraction of the butadiene rubber is 100 parts, optionally, the mass fraction of the plasticizer is 1 to 10 parts, that is, the content of the plasticizer is 1% to 10% of a total amount of the butadiene rubber. Actually, with increase of the dosage of the plasticizer, the glass-transition temperature of the butadiene rubber material is decreased, but correspondingly, the tensile strength of the v butadiene rubber will be reduced, too. When the content of the plasticizer is 10, the tensile strength of the butadiene rubber is reduced to a great extent. In addition, excessive plasticizer will be separated out from the interior of the butadiene rubber material, such that the mechanical property of the butadiene rubber material will be reduced. When the mass fraction of the plasticizer meets the range, it can be ensured that performance of the butadiene rubber can meet the requirement on performance of the vibrating diaphragm. Preferably, the mass fraction of the plasticizer is 3 to 7 parts, that is, the content of the plasticizer is 3% to 7% of the total amount of the plasticizer. Of course, those skilled in the art can make flexible adjustment according to a specific requirement, which is not limited herein.

Optionally, the internal releasing agent can be blended in the butadiene rubber. The internal releasing agent is at least one of stearic acid, stearate, octadecylamine, alkyl phosphate and α-octadecyl-ω-hydroxyl polyoxyethylene phosphate.

In the embodiment of the present disclosure, under a circumstance that the mass fraction of the butadiene rubber is 100 parts, the mass fraction of the internal releasing agent is 0.5 to 5 parts, that is, the content of the internal releasing agent is 0.5% to 5% of a total amount of the butadiene rubber.

The demolding capacity of the butadiene rubber is related to the mass fraction of the internal releasing agent. Specifically speaking, when the mass fraction of the releasing agent is small, the forming state of the butadiene rubber is good but the demolding capacity is poor. When the mass fraction of the releasing agent is great, the demolding performance of the butadiene rubber is improved obviously, but it is easy to separate out the releasing agent in the formed butadiene rubber to be accumulated on the surface of a mold to pollute the mold. It is found by the inventor that when the mass fraction of the internal releasing agent is 1-3 parts, that is, the content of the internal releasing agent is 1% to 3% of a total amount of internal releasing agent, the formed internal releasing agent is good in forming state with small residues after being formed. Of course, those skilled in the art can make flexible adjustment according to a specific requirement, which is not limited herein.

Optionally, the vulcanizer can be blended in the butadiene rubber. Optionally, the vulcanizer is at least one of a sulfur vulcanizer, an organic peroxide vulcanizer and a thiuram vulcanizer.

When the vulcanizer is the sulfur vulcanizer, it is proper that the content of the sulfur vulcanizer is 0.3% to 1.5% of the total amount of butadiene rubber. Compared with other rubber, activity of double bonds of butadiene rubber is relatively low, such that fewer sulfur can reach the vulcanizing effect.

The thiuram polysulfide is at least one of tetramethylthiuram monosulfide, tetramethylthiuram disulfide, tetraethylthiuram disulfide, tetrabutylthiuram disulfide, diisobutylthiuram disulfide, bis(1,5-pentylidene) thiuram tetrasulfide.

The thiuram polysulfide is a vulcanizer of a sulfur-free system, which can vulcanize rubber directly if being used independently. After the temperature is raised to the vulcanizing temperature, a sulfur-containing compound is split to active sulfur. As the structure of the sulfide is different, the sulfur contents are different, too. In the vulcanizing process, the sulfur-containing compound is heated to be split to free radicals which are then acted with α-methyne in the butadiene rubber to complete vulcanizing action according to a reaction of a free radial chain. Under a circumstance of no zinc oxide, it is decomposed to dimethylamine and carbon disulfide, and a decomposed product plays a role of promoting oxidization of rubber, such that the aging performance is decreased severely. Under a circumstance of presence of zinc oxide, it can be reacted to generate zinc dimethyldithiocarbamate which plays a positive role in aging resistance of the rubber.

Optionally, the organic peroxide vulcanizer is at least one of 1,3-1,4-(tertiary butyl peroxy-isopropyl)benzene, dicumyl peroxide, 2,5-dimethyl-2,5-bis(tertiary butyl peroxy) hexane, tertiary butyl dicumyl peroxide, 2,5-dimethyl-2,5-bis(peroxy tertiary butyl)-3-hexyne, 4,4′-bis(tertiary butyl peroxy) N-butyl valerate, 1,1′-bis(tertiary butyl peroxy)-3,3,5-trimethyl-cyclohexane, 2,4-dichlorobenzoyl peroxide. The content of the organic peroxide vulcanizer is 2% to 8% of the total amount of the butadiene rubber. Organic peroxides shall be controlled reasonably, and if the content is excessive, the tensile strength of the butadiene rubber is influenced.

Optionally, a glass-transition temperature of the vibrating diaphragm ranges: from −120° C. to 0° C. As the butadiene rubber has a relatively high molecular weight and the molecular chain thereof is relatively flexible, the butadiene rubber is relatively good in low-temperature resistance. When the vibrating diaphragm meets the range of the glass-transition temperature, the vibrating diaphragm of the sound-producing apparatus can be kept at high elasticity at a constant temperature, such that the vibrating diaphragm is good in rebound resilience. Within a certain range, as the glass-transition temperature is lower, the vibrating diaphragm can work normally at a lower temperature. Under the circumstance that the thickness of the vibrating diaphragm is not changed, the lower the glass-transition temperature is, the lower the resonant frequency F0 of the assembled sound-producing apparatus is. The glass-transition temperature of the material can be adjusted by changing the content of the inorganic filler reinforcing agent and the content of the plasticizer in the butadiene rubber.

In an embodiment, the glass-transition temperature of the vibrating diaphragm provided by the present disclosure is preferably −60° C. to −20° C. The vibrating diaphragm not only maintains high elasticity at normal temperature, but also is good in rebound resilience. It is of more importance that even at a temperature below 0° C., or even a more extreme temperature, the vibrating diaphragm of the sound-producing apparatus still can keep relatively good rubber elasticity, such that the sound-producing apparatus shows relatively high tone quality. Meanwhile, the risk of breaking the vibrating diaphragm of the sound-producing apparatus in the low-temperature environment is reduced, thereby improving reliability,

The elongation at break of the vibrating diaphragm is greater than 100%. Optionally, the elongation at break of the vibrating diaphragm is greater than 150%. The vibrating diaphragm provided by the present disclosure is relatively high in elongation at break, such that the reliability problem such as diaphragm breakage is not prone to occur when the vibrating diaphragm is used in the sound-producing apparatus.

Under same stress, the strain of the vibrating diaphragm provided by the embodiment of the present disclosure is obviously smaller than that of the PEEK vibrating diaphragm in the prior art. It proves that the Young modulus of the vibrating diaphragm provided by the embodiment of the present disclosure is obviously smaller than that of the PEEK vibrating diaphragm in the prior art.

In addition, the PEEK vibrating diaphragm in the prior art forms an obvious yield point which is about 0.4% to 0.5% of strain. The vibrating diaphragm of the speaker provided by the present disclosure is free of yield point. It proves that the vibrating diaphragm provided by the present disclosure has a wider elastic area and excellent resilience.

The vibrating diaphragm prepared by the butadiene rubber has good flexibility. For example, the elongation at break thereof is greater than or equal to 100%. The butadiene rubber molecular chain has important influence on elongation at break and those skilled in the art can select according to an actual need. The vibration displacement of the vibrating diaphragm of the sound-producing apparatus is larger and the loudness is higher. Further, it is good in reliability and durability. The better the flexibility of the butadiene rubber material is, the greater the elongation at break is, and the higher the ability of the vibrating diaphragm resisting damage is. When the vibrating diaphragm vibrates in a large vibrating amplitude state, the butadiene rubber generates relative large strain, and the vibrating diaphragm material has the risk of diaphragm fold, diaphragm rupture or diaphragm damage during long-time vibration. By contrast, the vibrating diaphragm taking butadiene rubber as a base material has good flexibility, thereby reducing the risk of breaking the vibrating diaphragm. The higher the elongation at break is, the lower the diaphragm rupture rate of the vibrating diaphragm in long-term use is.

Compared with the engineering plastics, the butadiene rubber material has a relatively wider elastic area. When strain of the vibrating diaphragm occurs in the area, the vibrating diaphragm is excellent in resilience after removing an external force. Correspondingly, there is less rocking vibration of the vibrating diaphragm in the vibrating process, and the tone quality and audition stability are more excellent. Further, the vibrating diaphragm provided by the present disclosure can be used continuously at a high temperature and compared with an existing material, and is higher in damping capacity. As the vibrating diaphragm is good in rebound resilience, the sound-producing apparatus has relatively good transient response and relatively low distortion.

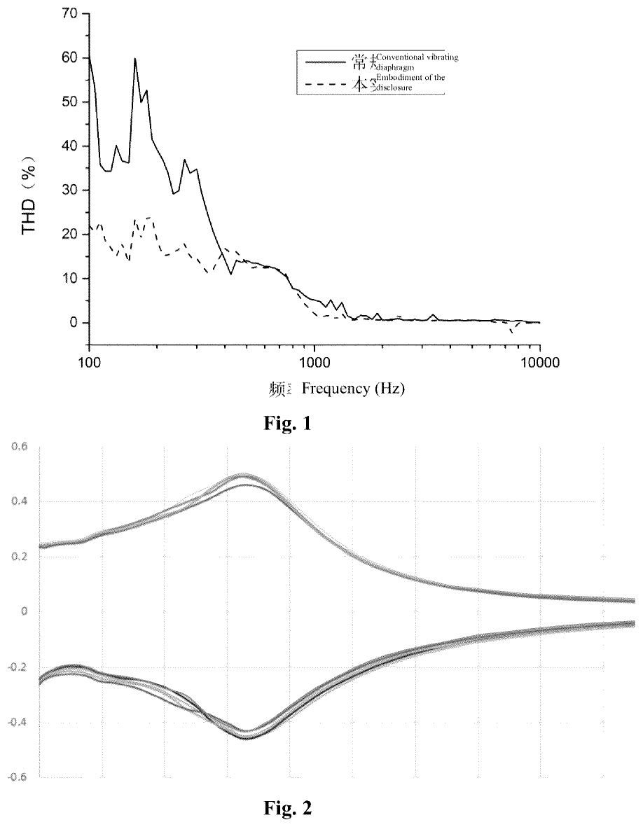

As shown in FIG. 1, the vibrating diaphragm provided by the present disclosure has a lower THD (total harmonic distortion) compared with that of the PEEK vibrating diaphragm in the prior art. It proves that the vibrating diaphragm provided by the present disclosure has a more excellent anti-polarization ability and is more excellent in tone quality.

The vibrating diaphragm provided by the present disclosure possesses high elasticity at room temperature, its molecular chain is easy to move, its intermolecular friction force is large, and the vibrating diaphragm is relatively good in damping capacity. Optionally, the loss factor of the vibrating diaphragm at room temperature is greater than 0.06. Due to the excellent damping property, the vibrating diaphragm has lower impedance. The damping property of the vibrating diaphragm is improved, and a vibrating system of the sound-producing apparatus is high in ability of inhibiting a polarization phenomenon in a vibrating process, such that the vibrating consistence is good. The vibrating diaphragm made of the existing engineering plastic is low in damping, the loss factor thereof is usually smaller than 0.01, and its damping property is small.

Preferably, the loss factor of the vibrating diaphragm at room temperature is greater than 0.1.

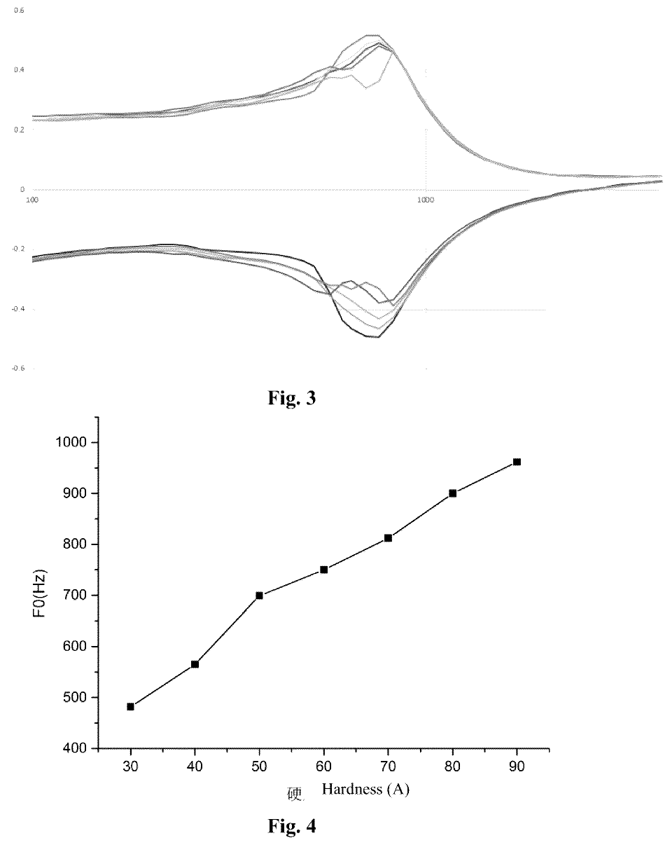

FIG. 2 shows a test curve of vibration displacement of different parts of the vibrating diaphragm of the sound-producing apparatus of an embodiment of the present disclosure at different frequencies. FIG. 3 shows a test curve of vibration displacement of different parts of the conventional vibrating diaphragm at different frequencies.

The vibrating diaphragm is a rectangular corrugated rim vibrating diaphragm. The transverse coordinate is frequency (Hz) and the vertical coordinate is loudness displacement (mm). Points in an edge position and a center position of a central portion of the vibrating diaphragm are acquired for testing.

It can be seen that the curves in the FIG. 2 are more centralized, while the curves in the FIG. 3 are relatively dispersed. It proves that the parts of the vibrating diaphragm provided by the embodiment of the present disclosure are better in vibrating consistence. In the vibrating process, rocking vibration of the vibrating diaphragm is less, and the tone quality and audition stability are more excellent.

The shore hardness of the vibrating diaphragm provided by the present disclosure is in a range of 30 A to 95 A. The resonant frequency F0 of the sound-producing apparatus is in direct proportion to the modulus and thickness of the vibrating diaphragm. As far as the butadiene rubber material is concerned, the modulus thereof is in direct proportion to the hardness. Thus, the modulus of the vibrating diaphragm can be reflected by hardness.

On one hand, strength and hardness of the butadiene rubber material can be adjusted by the reinforcing agent. On the other hand, increased molecular chain weight will cause the number of intermolecular hydrogen bonds to increase, thereby increasing strength and hardness of the butadiene rubber as well as the number of the crosslinking points. The higher the strength and hardness of the butadiene rubber material are, the higher the F0 of the vibrating diaphragm material is, and correspondingly reducing loudness of the sound-producing apparatus and degrading the low pitch performance. FIG. 4 shows an impedance curve of the vibrating diaphragms with different hardness and with the same thickness. It can be seen from the FIG. 4 that with increase of hardness, the resonant frequency F0 of the sound-producing apparatus is rapidly increased.

The vibrating diaphragm of the sound-producing apparatus provided by the present disclosure can be a corrugated rim vibrating diaphragm or plate vibrating diaphragm. The resonant frequency F0 of the sound-producing apparatus is in direct proportion to the Young modulus and thickness of the vibrating diaphragm, and change of F0 can be realized by changing the thickness and the Young modulus of the vibrating diaphragm. A specific adjusting principle is as follows:

$$F 0 = \frac{1}{2 π} \sqrt{\frac{1}{CmsMms}} ;$$

wherein Mms is the equivalent vibrating mass of the sound-producing apparatus, and Cms is the equivalent compliance of the sound-producing apparatus;

$$Cms = \frac{( {C}_{m 1} * {C}_{m 2} )}{( {C}_{m 1} + {C}_{m 2} )} ;$$

wherein Cₘ₁ is the damper compliance and Cₘ₂ is the vibrating diaphragm compliance. In a design without a damper, the equivalent compliance of the sound-producing apparatus is the vibrating diaphragm compliance:

$${C}_{m 2} = \frac{( 1 - {u}^{3} ) {W}^{3}}{π ( W + dvc ) {t}^{3} {Ea}_{1} {a}_{2}} ;$$

wherein W is the total width of a corrugated rim part of the vibrating diaphragm, t is the thickness of the diaphragm, dvc is the fitting outer diameter of a voice coil fitted to the vibrating diaphragm, E is the Young modulus of the vibrating diaphragm material, and u is the Poisson ratio of the vibrating diaphragm material.

It can be seen that the resonant frequency F0 of the sound-producing apparatus is in direct proportion to the modulus and thickness of the vibrating diaphragm. Further, the modulus of the vibrating diaphragm is in direct proportion to its hardness. Thus, its modulus can be replaced by hardness. In order to obtain full low pitch and comfortable hearing feeling, the vibrating diaphragm has enough rigidity and damping while the miniature sound-producing apparatus has relatively low resonant frequency F0. Those skilled in the art can adjust the amplitude of F0 by adjusting hardness and thickness of the vibrating diaphragm of a speaker.

The shore hardness of the vibrating diaphragm is preferably 30 A to 80 A, and the hardness of the vibrating diaphragm is 30 μm to 120 μm. In the preferred range, the resonant frequency F0 of the sound-producing apparatus reaches 150 Hz to 1500 Hz. The low frequency performance of the sound-producing apparatus is excellent.

Optionally, the vibrating diaphragm provided by the present disclosure can either be a single-layered vibrating diaphragm or a multilayered composite vibrating diaphragm. The single-layered vibrating diaphragm is a vibrating diaphragm composed of a butadiene rubber film layer. The composite vibrating diaphragm is the vibrating diaphragm thrilled by stacking multiple butadiene rubber film layers in sequence. Alternatively, the composite vibrating diaphragm can include at least one butadiene rubber film layer, and the butadiene rubber film layer is combined with the film layer prepared by other materials layer by layer to form the composite vibrating diaphragm prepared by various materials. In addition, multiple film layers can be combined by way of hot-pressing and the like, thereby forming the composite vibrating diaphragm. The composite vibrating diaphragm may include two, three, four or five film layers, which is not limited here. At least one film layer in the composite vibrating diaphragm is the butadiene rubber film layer prepared from the butadiene rubber provided by the present disclosure.

The thickness of the butadiene rubber film layer is 10 μm to 200 μm, preferably 30 μm to 120 μm. When the thickness of the butadiene rubber film layer is in the range, demands on performance of the sound-producing apparatus and on space for assembling can be better met.

In addition, thickness of the vibrating diaphragm will influence its acoustic performance. Normally, the relatively low thickness will influence the reliability of the vibrating diaphragm and the relatively high thickness will influence the sensitivity of the vibrating diaphragm. Thus, the thickness of the vibrating diaphragm provided by the present disclosure can be controlled for example in the range of 30 μm to 120 μm. When the thickness range of the single-layered butadiene rubber is 30 μm to 120 μm, this thickness range can. make the sensibility of the vibrating diaphragm of the sound-producing apparatus be higher, the elastic performance and the rigid performance of the vibrating diaphragm meet the manufacturing requirement of the sound-producing apparatus. The vibrating diaphragm can be in particular applied to a miniature sound-producing apparatus. As the most fragile component in the sound-producing apparatus, the vibrating diaphragm can further guarantee long-term normal use in a repeated vibrating process, thereby prolonging the service life of the sound-producing apparatus.

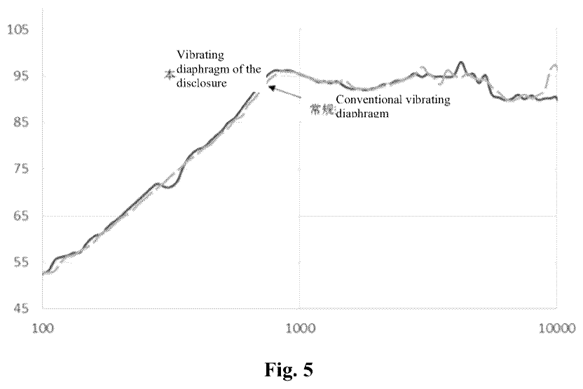

The present disclosure further provides a comparison curve diagram between a specific embodiment of the vibrating diaphragm provided by the present disclosure and the existing conventional vibrating diaphragm, as shown in the FIG. 5. FIG. 5 shows a test cure (SPL curve) of loudness of the two kinds of vibrating diaphragms at different frequencies. The vibrating diaphragms are the rectangular corrugated rim vibrating diaphragms. The transverse coordinate is frequency (Hz) and the vertical coordinate is loudness.

In the FIG. 5, the solid line shows a test curve provided by the present disclosure. A dotted line shows a test curve of the conventional vibrating diaphragm. It can be seen from the SPL curve that the intermediate frequency performance of the two vibrating diaphragms are similar. The F0 of the sound-producing apparatus of the vibrating diaphragm provided by the present disclosure is 856 Hz. The F0 of the sound-producing apparatus adopting the conventional vibrating diaphragm is 926 Hz. It proves that the low frequency sensitivity of the vibrating diaphragm provided by the present disclosure is better than that of an existing PEEK vibrating diaphragm. That is, the sound-producing apparatus adopting the vibrating diaphragm provided by the present disclosure is higher in loudness and comfort level.

The vibrating diaphragm provided by the present disclosure is prepared by mixing the butadiene rubber material with an auxiliary agent and conducting hot pressing by integral formation. The vibrating diaphragm provided by the present disclosure is simple in preparation method, can be normally used under the condition of extremely low-temperatures, and also takes into consideration rigidity, rebound resilience and damping property of the vibrating diaphragm.

On the other hand, further provided is a sound-producing apparatus.

The sound-producing apparatus includes a sound-producing apparatus main body and the vibrating diaphragm made of the butadiene rubber. The butadiene rubber is any one of nickel butadiene rubber, rare earth butadiene rubber and cobalt butadiene rubber, which is not limited herein. The vibrating diaphragm is provided on the sound-producing apparatus main body and the vibrating diaphragm is configured to vibrate to generate a sound. The sound-producing apparatus main body can be provided with components such as a coil and a magnetic circuit system, and the vibrating diaphragm is driven to vibrate by electromagnetic induction. The sound-producing apparatus provided by the present disclosure, for example, can be an earphone, an intelligent watch or the like, and can be used normally under a low-temperature condition.

Although detailed description to some specific embodiments of the present disclosure has been made by way of illustration, those skilled in the art understand that the examples are used for explanation only, rather than to limit the scope of the present disclosure. Those skilled in the art understand that modifications on the embodiment can be made without departing from the scope or the spirit of the present disclosure. The scope of the present disclosure is limited by the appended claims.

1. A vibrating diaphragm of a sound-producing apparatus, the vibrating diaphragm comprising at least one elastomer layer
comprising a butadiene rubber selected from the group consisting of nickel butadiene rubber, rare earth butadiene rubber and cobalt butadiene rubber, and having a cis-form content greater than 80%;
wherein the butadiene rubber comprises a molecular structural formula as follows:

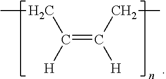

2. The vibrating diaphragm of claim 1, further comprising an inorganic filler reinforcing agent blended in the butadiene rubber, wherein the inorganic filler reinforcing agent is selected from the group consisting of carbon black, white carbon black, nano titanium dioxide, talc powder, precipitated calcium carbonate and barium sulfate.

3. The vibrating diaphragm of claim 2, wherein the content of the inorganic filler reinforcing agent is 15% to 90% of the butadiene rubber.

4. The vibrating diaphragm of claim 1, further comprising a vulcanizer blended in the butadiene rubber, wherein the vulcanizer is selected from the group consisting of a sulfur vulcanizer, an organic peroxide vulcanizer and a thiuram vulcanizer.

5. The vibrating diaphragm of claim 4, wherein the content of the sulfur vulcanizer is 0.3% to 1.5% of the butadiene rubber.

6. The vibrating diaphragm of claim 4, wherein the thiuram vulcanizer is selected from the group consisting of tetramethylthiuram monosulfide, tetramethylthiuram disulfide, tetraethylthiuram disulfide, tetrabutylthiuram disulfide, diisobutylthiuram disulfide, bis(1,5-pentylidene) thiuram tetrasulfide.

7. The vibrating diaphragm of claim 4, wherein the organic peroxide vulcanizer is selected from the group consisting of 1,3-1,4-di(tertiary butyl peroxy-isopropyl)benzene, dicumyl peroxide, 2,5-dimethyl-2,5-bis(tertiary butyl peroxy) hexane, tertiary butyl dicumyl peroxide, 2,5-dimethyl-2,5-bis(peroxy tertiary butyl)-3-hexyne, 4,4′-bis(tertiary butyl peroxy) N-butyl valerate, 1,1′-bis(tertiary butyl peroxy)-3,3,5-trimethyl-cyclohexane, 2,4-dichlorobenzoyl peroxide, and the content of the organic peroxide vulcanizer is 2% to 8% of the butadiene rubber.

8. The vibrating diaphragm of claim 1, further comprising are antiaging agent blended in the butadiene rubber, wherein the antiaging agent is selected from the group consisting of antiaging agent N-445, antiaging agent 246, antiaging agent 4010, antiaging agent SP, antiaging agent RD, antiaging agent ODA, antiaging agent OD and antiaging agent WH-02, wherein the mass fraction of the nitrile rubber is 100 parts, and the content of the antiaging agent is 0.5% to 10% of the butadiene rubber.

9. The vibrating diaphragm of claim 8, wherein the content of the antiaging agent is 1% to 5% of the butadiene rubber.

10. The vibrating diaphragm of claim 1, further comprising a plasticizer blended in the butadiene rubber, wherein the plasticizer is selected from the group consisting of an aliphatic diester plasticizer, a phthalate plasticizer, a benzene polyacid plasticizer, a benzoate plasticizer, a polyalcohol ester plasticizer, a chlorinated hydrocarbon plasticizer, an epoxy plasticizer, a citrate plasticizer and a polyester plasticizer, and wherein the content of the plasticizer is 1% to 10% of the butadiene rubber.

11. The vibrating diaphragm of claim 10, wherein the content of the plasticizer is 3% to 7% of the butadiene rubber.

12. The vibrating diaphragm of claim 1, further comprising an internal releasing agent blended in the butadiene rubber, wherein the internal releasing agent is selected from the group consisting of stearic acid, octadecylamine, alkyl phosphate and α-octadecyl-ω-hydroxyl polyoxyethylene phosphate, and the content of the internal releasing agent is 0.5% to 5% of the butadiene rubber.

13. The vibrating diaphragm of claim 12, wherein the content of the internal releasing agent is 1% to 3% of the butadiene rubber.

14. The vibrating diaphragm of claim 1, wherein the vibrating diaphragm is selected from the group consisting a single-layered vibrating diaphragm comprising one butadiene rubber film layer; and
a composite vibrating diaphragm including two or more film layers, including a butadiene rubber film layer.

15. The vibrating diaphragm of claim 14, a thickness of the butadiene rubber film layer is 10 μm to 200 μm.

16. (canceled)

17. The vibrating diaphragm of claim 1, wherein a hardness of the butadiene rubber is 30 A to 95 A.

18. The vibrating diaphragm of claim 1, wherein a glass-transition temperature of the butadiene rubber ranges from −120° C. to 0° C.

19. The vibrating diaphragm of claim 1, wherein a loss factor of the butadiene rubber at a room temperature is greater than 0.06.

20. The vibrating diaphragm of claim 1, wherein an elongation at break of the butadiene rubber is greater than 100%.

21. A sound-producing apparatus, comprising a sound-producing apparatus main body and the vibrating diaphragm of claim 1, the vibrating diaphragm being disposed on the sound-producing apparatus main body and the vibrating diaphragm being configured to vibrate to generate a sound.
